(19) United States
(12) Patent Application Publication
(10) Pub. No.: US 2026/0048654 A1
(43) Pub. Date: Feb. 19, 2026

(54) FUEL TANK ISOLATION VALVE

(71) Applicant: Stant Automotive Systems (Suzhou) Co., Ltd., Suzhou (CN)

(72) Inventors: Jian Liu, Suzhou (CN); Zhi-cheng Jin, Suzhou (CN); Biao Zhou, Suzhou (CN); Chong Shen, Suzhou (CN); Rong-fei He, Suzhou (CN)

(21) Appl. No.: 19/298,102

(22) Filed: Aug. 12, 2025

(30) Foreign Application Priority Data
Aug. 13, 2024 (CN) 202411106020.7

(51) Int. Cl. B60K 15/035; B60K 15/03

(52) U.S. Cl. CPC B60K 15/03519; B60K 2015/03302; B60K 2015/0358

(57) ABSTRACT

The present disclosure relates to the field of automobile valve, specifically to a fuel tank isolation valve. Including: a separating valve main body, the separating valve main body is internally provided with a valve cavity, the valve cavity is internally provided with a clapboard; an electromagnetic valve, the electromagnetic valve is installed on the isolation valve main body, the electromagnetic valve comprises a movable plunger extending into the valve cavity, the front end of the movable plunger is provided with a plug, the plug is opposite to the clapboard, one side of the movable plunger far away from the clapboard is propped against with a first spring; further comprising: a temporary power-off pressure relief device, the temporary power-off pressure relief device comprises a limiting seat, a sliding seat and a conversion device, the sliding seat is set at the front end of the electromagnetic valve body, the limiting seat is set on the movable plunger; the limiting seat and the sliding seat are respectively provided with axially opposite locking projections and convex eaves; the conversion device is used for converting the axial driving force of the movable plunger to the limiting seat to drive the limiting seat to rotate in the circumferential direction in one way; one side of the convex eave is provided with a first sliding groove for containing the convex axial sliding of the lock. It can realize the function of temporary power-off and pressure relief.

### PRIORITY CLAIM

This application claims priority to Chinese Application No. 202411106020.7, filed Aug. 13, 2024, which is hereby incorporated herein.

### FIELD OF THE DISCLOSURE

The present disclosure relates to the field of automobile valves, specifically to a fuel tank isolation valve.

### BACKGROUND

For fuel systems, to accommodate and meet the various operating conditions of the engine, fuel tank isolation valves can maintain and regulate the pressure within the fuel tank and its associated piping. In addition, these valves can control the flow rate during fuel tank pressure relief to ensure it does not exceed a predetermined value.

During the production process of motor vehicles, after the fuel tank and fuel tank isolation valve are assembled on the final assembly line and before the vehicle is powered on, the fuel tank is pre-filled with fuel to prepare for subsequent testing and startup. However, at this stage, since the system is not powered, many existing fuel tank isolation valves remain in a normally closed state due to power disconnection, preventing the fuel tank from venting to atmospheric pressure. During the fueling process, air inside the tank cannot be expelled quickly, thereby affecting fueling efficiency and, consequently, the overall assembly efficiency of the motor vehicle. Therefore, there is a need to design a fuel tank isolation valve capable of temporarily venting without electrical power to relieve pressure.

### SUMMARY

To overcome the shortcomings of the existing technology, the present disclosure provides a fuel tank isolation valve capable of achieving temporary power-off pressure relief.

The illustrative fuel tank isolation valve can comprise an isolation valve body, an electromagnetic valve, and a temporary power off pressure relief device. The isolation valve body includes a valve cavity, and the valve cavity includes a partition plate. The partition plate is provided with through holes communicating with the flow passages on both sides of the partition plate. The electromagnetic valve can be mounted on the isolation valve body and can include a movable plunger extending into the valve cavity. The front end of the movable plunger can be provided with a plug. The plug can face the partition plate, and the side of the movable plunger remote from the partition plate can be in contact with a first spring.

During a pressure-holding state, the electromagnetic valve is de-energized, and the first spring pushes the movable plunger to block the through hole with the plug. During a first pressure-relief state, the electromagnetic valve is energized, and the movable plunger retracts toward the direction away from the partition plate to open the through hole.

The temporary power off pressure relief device is configured to selectively enable a second pressure relief state. During the second pressure relief state: the electromagnetic valve is de-energized, and the first spring pushes the movable plunger to axially abut the temporary power off pressure relief device, thereby restricting the plug from blocking the through hole.

The temporary power off pressure relief device includes a limit seat, a slide seat, and a conversion device. The slide seat is mounted on the front end of the electromagnetic valve body, and the limit seat is mounted on the movable plunger. The limiting seat and the slide seat are respectively provided with axially opposing lock protrusions and flanges that cooperate to block the plunger and plug from blocking the through hole.

A conversion device is used to convert the axial driving force of the movable plunger on the limit seat into a driving force for the limit seat to rotate unidirectionally in the circumferential direction. The protruding flange has a first slide groove on one side for accommodating the axial sliding of the locking protrusion. The conversion device further comprises a rotational blocking structure, when the locking protrusion rotates into the first slide groove, the blocking structure is used to restrict the limit seat from continuing to rotate in the circumferential direction.

### BRIEF DESCRIPTIONS OF THE DRAWINGS

FIG. 1 is a schematic diagram of an fuel tank isolation valve according to an embodiment of the present application;

FIG. 2 is a sectional view of an fuel tank isolation valve according to Embodiment 2 of the present application;

FIG. 3 is an enlarged view of the area marked A in FIG. 2;

FIG. 4 is a sectional view of the temporary power off pressure relief device in Example 2 of the present application;

FIG. 5 is an exploded view of the components of the temporary power-off pressure relief device in Example 2 of the present application;

FIG. 6 is an enlarged view of the slide block in FIG. 5;

FIG. 7 is a structural schematic diagram of the sliding seat in Example 2 of the present application;

FIG. 8 is a structural schematic diagram of the pressure plate in Example 2 of the present application;

FIG. 9 is a positional schematic diagram of the limiting seat and the sliding seat in Example 2 of the present application (with the lock protrusion inserted into the slot);

FIG. 10 is a positional schematic diagram of the limiting seat and the sliding seat in Example 2 of the present application (the locking protrusion abuts against the locating slot);

FIG. 11 is a positional schematic diagram of the limiting seat and the sliding seat in Example 2 of the present application (with the lock protrusion in the first sliding slot);

FIG. 12 is a sectional view of an fuel tank isolation valve in Example 3 of the present application;

FIG. 13 is a partial enlarged view of the area B in FIG. 12;

FIG. 14 is a positional schematic diagram of the limiting seat and the sliding seat in Example 3 of the present application (the lock protrusion is in the installation slot);

FIG. 15 is a schematic diagram showing the relative positions of the limiting seat and the sliding seat in Example 3 of the present application (the locking protrusion contacts the positioning tab).

FIG. 16 is a schematic diagram showing the relative positions of the limiting seat and the sliding seat in Example 3 of the present application (the lock protrusion is in the first sliding groove);

FIG. 17 is an exploded view of the components of the temporary power-off pressure relief device in Example 3 of the present application from the first perspective; and

FIG. 18 is an exploded view of the components of the temporary power-off pressure relief device in Example 3 of the present application from a second perspective.

### DETAILED DESCRIPTION

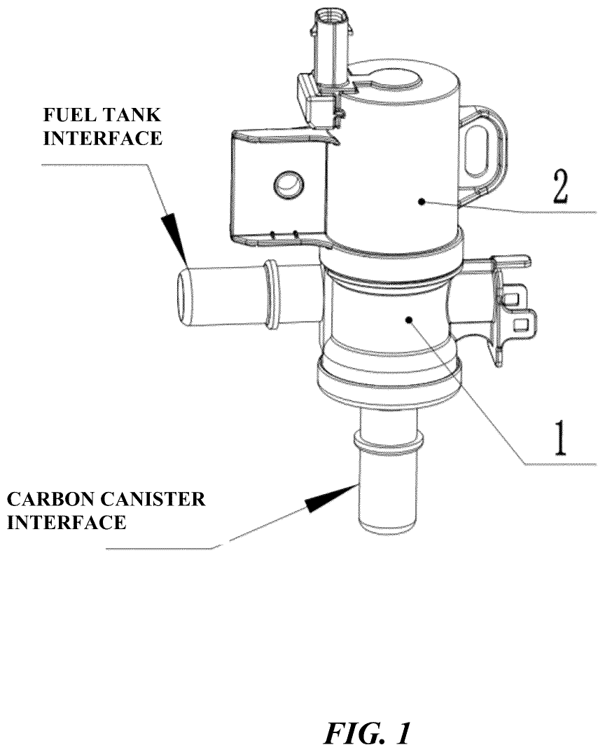

An illustrative fuel tank isolation valve can comprise an isolation valve body 1, an electromagnetic valve 2, and a temporary power off pressure relief device 3 as shown in FIG. 1. The isolation valve body 1 includes a valve cavity 10, and the valve cavity 10 includes a partition plate 101. The partition plate 101 is provided with through holes 1011 communicating with the flow passages on both sides of the partition plate 101. The electromagnetic valve 2 can be mounted on the isolation valve body 1 and can include a movable plunger 21 extending into the valve cavity. The front end of the movable plunger 21 can be provided with a plug 211. The plug 211 can face the partition plate 101, and the side of the movable plunger 21, remote from the partition plate, can be in contact with a first spring.

During a pressure-holding state, the electromagnetic valve is de-energized, and the first spring pushes the movable plunger to block the through hole with the plug. During a first pressure-relief state, the electromagnetic valve is energized, and the movable plunger retracts toward the direction away from the partition plate to open the through hole.

The temporary power off pressure relief device is configured to selectively enable a second pressure relief state. During the second pressure relief state: the electromagnetic valve is de-energized, and the first spring pushes the movable plunger to axially abut the temporary power off pressure relief device, thereby restricting the plug from blocking the through hole.

The temporary power off pressure relief device includes a limit seat, a slide seat, and a conversion device. The slide seat is mounted on the front end of the electromagnetic valve body, and the limit seat is mounted on the movable plunger. The limiting seat and the slide seat are respectively provided with axially opposing lock protrusions and flanges that cooperate to block the plunger and plug from blocking the through hole.

A conversion device is used to convert the axial driving force of the movable plunger on the limit seat into a driving force for the limit seat to rotate unidirectionally in the circumferential direction. The protruding flange has a first slide groove on one side for accommodating the axial sliding of the locking protrusion. The conversion device further comprises a rotational blocking structure, when the locking protrusion rotates into the first slide groove, the blocking structure is used to restrict the limit seat from continuing to rotate in the circumferential direction.

In the fuel tank isolation valve of the present application, the conversion device includes a circumferentially locked drive unit, which is disposed on the axial side of the limiting seat. The drive unit has drive teeth on the side near the limiting seat, and the limiting seat has drive teeth opposite the drive teeth. A guide slope is provided between the drive teeth and the drive teeth.

When the electromagnetic valve is energized, the movable plunger axially compresses the limiting seat and the drive unit, causing the drive teeth to axially press against the drive teeth. At this point, the guide ramp is used to push the drive teeth to rotate circumferentially. As a preferred embodiment of the present disclosure, through the wedge-shaped engagement between the drive teeth and the drive teeth, the axial pressure output by the movable plunger can be converted into rotational driving force.

In some embodiments, in the fuel tank isolation valve of the present application, the drive unit is a pressure plate, which is disposed on the side of the limiting seat near the plug. The pressure plate is mounted on the movable plunger, and the drive teeth are disposed on the pressure plate. Opposite the drive teeth, the limit seat is provided with drive teeth, and the limit seat is slidably mounted on the movable plunger. The side of the limit seat opposite the plug is provided with a limit support portion;

When the solenoid valve is energized, the movable plunger axially pushes the pressure plate to axially press the drive teeth against the transmission teeth. At this time, the limiting support portion is used to support the limiting seat.

Further, in the fuel tank isolation valve of the present application, a circumferential locking structure is provided between the pressure plate and the sliding seat, including a positioning protrusion extending outward from the pressure plate and a second sliding groove extending axially inward from the sliding seat, wherein the positioning protrusion is slidably disposed within the second sliding groove.

Furthermore, in the fuel tank isolation valve of the present application, the pressure plate is slidably mounted on the movable plunger, and the movable plunger has a pressing surface corresponding to the upper end of the pressure plate. As a preferred embodiment of the present application, the pressure plate is axially driven to move by the pressing surface.

Preferably, in the fuel tank isolation valve of the present application, the drive unit is fixedly mounted on the side of the limiting seat remote from the plug; when the solenoid valve is energized, the movable plunger axially pushes the limiting seat to axially press the drive tooth against the transmission tooth. As a preferred embodiment of the present application, based on the above structure, the drive unit can be integrated into the front end of the electromagnetic valve body or the bottom end of the slide seat, eliminating the need for the pressure plate and reducing production costs.

In the fuel tank isolation valve of the present application, the limiting seat is disk-shaped and is mounted on the movable plunger, with corresponding limiting projections on the movable plunger corresponding to the limiting seat to limit the axial movement of the limiting seat. As a preferred embodiment of the present application, the separately manufactured limiting seat facilitates manufacturing.

In some embodiments, the fuel tank isolation valve of the present application, the limiting seat is provided with a first installation slot, which extends radially outward from the center hole of the limiting seat corresponding to the movable plunger to the outer edge of the limiting seat. The sliding seat is provided with a cavity for accommodating the rotation of the limiting seat, and the cavity is used to restrict the radial movement of the limiting seat. As a preferred embodiment of the present application, this facilitates the installation of the limiting seat from the movable plunger side.

In embodiments of the fuel tank isolation valve of the present application, the protruding flange near the locking protrusion is provided with at least a pair of inclined teeth, and positioning slots are provided between adjacent inclined teeth. When in the second pressure relief state, the locking protrusion abuts against the positioning slots.

In the unidirectional rotational direction of the limiting seat, the tooth surface of the inclined teeth near the first slide slot is inclined in the circumferential direction, and the tooth surface of the inclined teeth away from the first slide slot is perpendicular to the circumferential direction. As a preferred embodiment of the present application, when the electromagnetic valve is de-energized, the movable plunger is acted upon by the force of the first spring and moves toward the partition plate, and the inclined teeth and positioning slots are used to restrict the limiting seat from rotating in the opposite direction during this process.

In some embodiments of the fuel tank isolation valve of the present application, the protruding flange is provided with an insertion slot, which extends axially outward and penetrates the protruding flange, and the insertion slot is adapted to the locking protrusion; in the unidirectional rotational direction of the limiting seat, the insertion slot is provided on the side of the protruding flange remote from the first slide slot. The mounting slot is used to accommodate the lock protrusion entering the slide seat when the limiting seat is axially mounted. The mounting slot is provided to facilitate mounting the limiting seat into the slide seat when the electromagnetic valve is de-energized. In the initial state, the lock protrusion is located within the mounting slot, at which point the limiting seat and the slide seat are axially unlocked, and the fuel tank isolation valve is in a pressure-holding state. When the electromagnetic valve is energized, the limiting seat is pushed so that the locking protrusion moves axially inward and exits the loading groove. Due to the action of the conversion device, after the locking protrusion exits the loading groove, the limiting seat rotates circumferentially, causing the locking protrusion to misalign with the loading groove. When the electromagnetic valve is de-energized again, the locking protrusion cannot enter the loading groove, and the isolation valve is in the second pressure-relief state.

The technical solutions in the present disclosure can have the following beneficial effects:
1. The present disclosure provides a fuel tank isolation valve, a principle of which is as follows: after the fuel tank isolation valve is in the second pressure relief state, the electromagnetic valve is subjected to at least one cycle of energization and de-energization, causing the lock protrusion to rotate into the first slide slot. At this point, the limit seat and the slide seat are axially unlocked. After the limit seat and the slide seat are axially unlocked, the temporary power-off pressure relief device becomes ineffective, and the electromagnetic valve continues to perform power-on and power-off operations. The fuel tank isolation valve then alternates continuously between the first pressure relief state and the pressure-holding state. This achieves the temporary power-off pressure relief function.
2. The present disclosure provides an fuel tank isolation valve that can automatically enter the second pressure relief state after completing the airtightness test in the pressure maintenance state by simply controlling the power supply to the solenoid valve, thereby offering the advantages of simple operation and high automation.

Specific implementation examples are explained below with reference to the accompanying drawings.

### Example 1

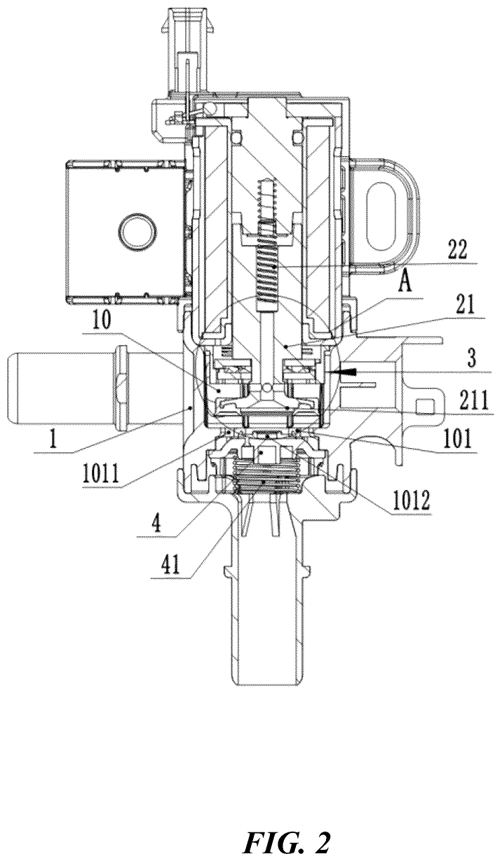

Referring to FIGS. 1 to 3 and FIGS. 12 to 13, this embodiment provides an fuel tank isolation valve, comprising:

Includes an isolation valve body 1, wherein the isolation valve body 1 comprises a valve cavity 10, and the valve cavity 10 comprises a partition plate 101, and the partition plate 101 is provided with a through hole 1011 for communicating the flow passages on both sides of the partition plate 101.

Electromagnetic valve 2, which is mounted on the isolation valve body 1. The electromagnetic valve 2 includes a movable plunger 21 extending into the valve cavity 10. The front end of the movable plunger 21 is provided with a plug 211, which faces the partition plate 101. The side of the movable plunger 21 remote from the partition plate 101 is in contact with a first spring 22.

In a pressure-holding state: The electromagnetic valve 2 is de-energized, and the first spring 22 pushes the movable plunger 21 to block the through hole 1011 with the plug 211.

In a first pressure relief state: When the electromagnetic valve 2 is energized, the movable plunger 21 retracts toward the direction away from the partition plate 101 and opens the through hole 1011.

In this embodiment, the movable plunger 21 is provided with a pressure relief channel 210, which extends out of the center of the plug 211. Corresponding to the pressure relief channel 210, the partition plate 101 is provided with a pressure relief hole 1012. The partition plate 101 on the side opposite the movable plunger 21 is provided with a pressure relief valve plug 4, which is elastically biased by the second spring 41 against the side of the pressure relief hole 1012 opposite the movable plunger 21. The through hole 1011 is located on the outer side of the pressure relief hole 1012, and the front end of the plug 211 is ring-shaped and corresponds to the through hole 1011. In the automotive fuel tank system, the flow passage on the side of the partition plate 101 corresponding to the movable plunger 21 is connected to the fuel tank, and the flow passage on the side of the partition plate 101 corresponding to the pressure relief valve plug 4 is connected to the carbon canister.

### Example 2

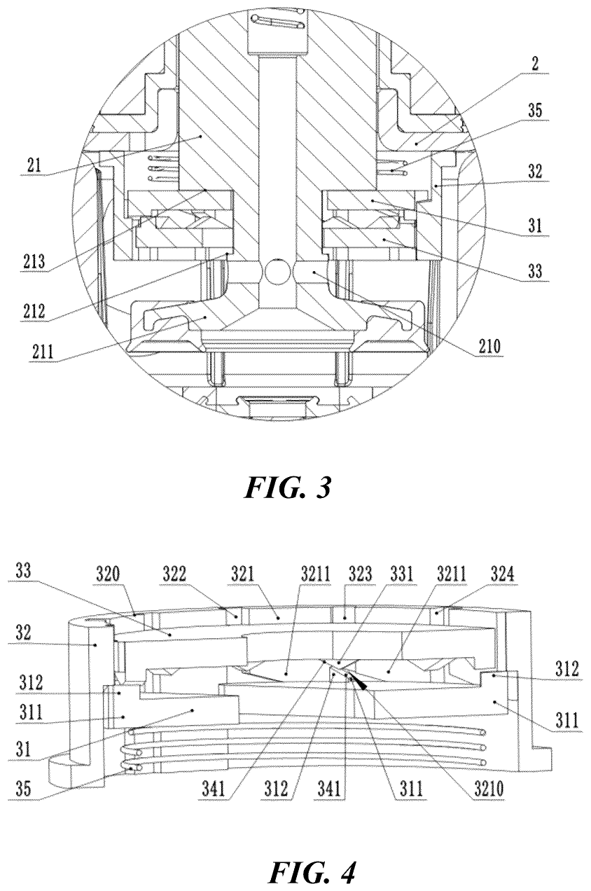

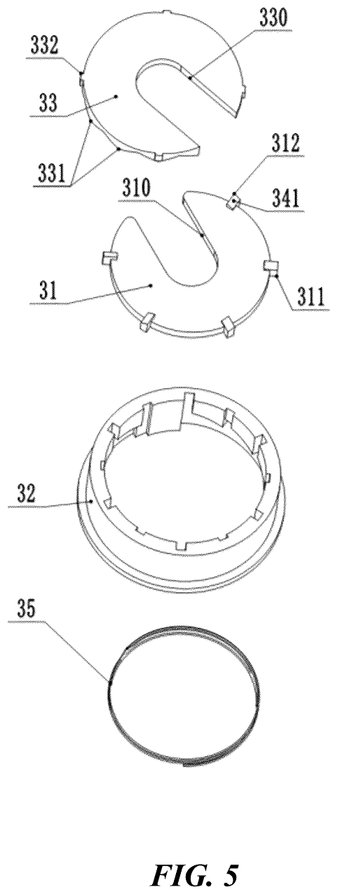

Based on Example 1, and in combination with FIGS. 3 to 5, the system further includes:

A temporary power-off pressure relief device 3, wherein the temporary power-off pressure relief device 3 includes a limit seat 31, a sliding seat 32, and a conversion device, wherein the sliding seat 32 is disposed at the front end of the electromagnetic valve 2 valve body, and the limit seat 31 is disposed on the movable plunger 21.

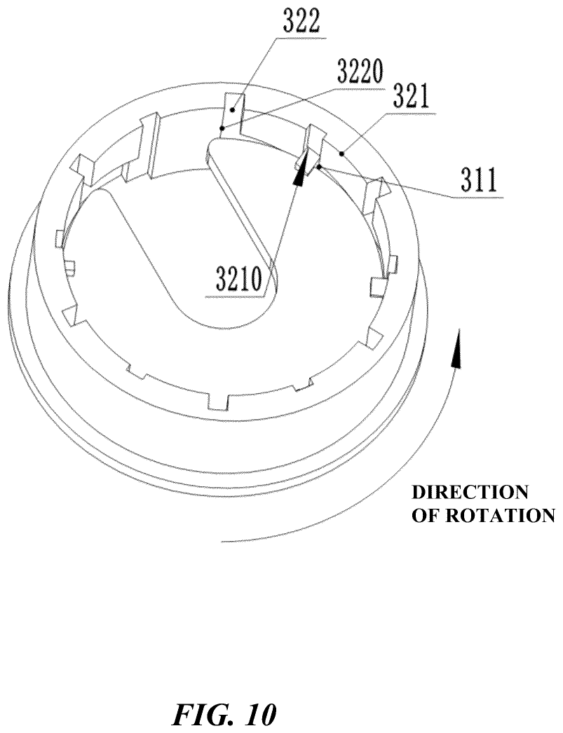

Second pressure relief state; When the electromagnetic valve 2 is de-energized, the first spring 22 pushes the movable plunger 21 to axially abut against the limiting seat 31 and the sliding seat 32, thereby restricting the plug 211 from blocking the through hole 1011. Correspondingly, as shown in FIG. 10, the limiting seat 31 and the sliding seat 32 are respectively provided with axially opposing lock protrusions 311 and protrusions 321.

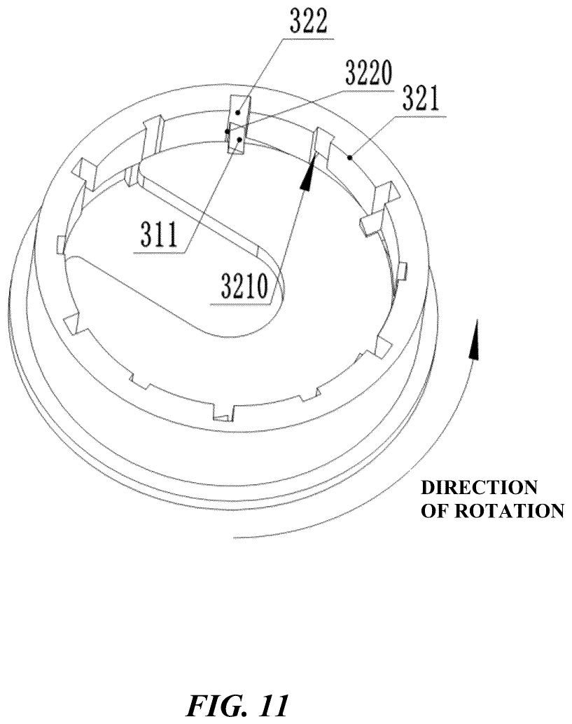

A conversion device is used to convert the axial driving force exerted by the movable plunger 21 on the limiting seat 31 into a driving force that causes the limiting seat 31 to rotate unidirectionally in the circumferential direction (the process of unidirectional rotation is shown in FIGS. 10 to 11); As shown in FIG. 11, the protruding flange 321 has a first slide groove 322 on one side for the axial sliding of the lock protrusion 311. The device further includes a rotational blocking structure. When the lock protrusion 311 rotates into the first slide groove 322, the blocking structure restricts the limiting seat 31 from continuing to rotate circumferentially.

In this embodiment, corresponding to the rotational blocking structure, the first slide groove 322 is provided with a side wall 3220 for restricting the limiting seat 31 from continuing to rotate circumferentially. Specifically, the side wall 3220 extends away from the plug head 211 in the direction of the protruding flange 321.

Based on the above structure, the principle of the fuel tank isolation valve is as follows: after the fuel tank isolation valve is in the second pressure relief state, the electromagnetic valve 2 is subjected to at least one cycle of energization and de-energization, causing the lock protrusion 311 to rotate into the first slide groove 322. At this point, the limit seat 31 and the slide seat 32 are axially unlocked. After the limit seat 31 and the sliding seat 32 are axially unlocked, the temporary power-off pressure relief device 3 becomes ineffective, and the electromagnetic valve 2 continues to perform power-on and power-off operations. The fuel tank isolation valve then alternates continuously between the first pressure relief state and the pressure-holding state. This achieves the temporary power-off pressure relief function. Specifically, in this embodiment, after the fuel tank isolation valve enters the second pressure relief state, the electromagnetic valve 2 is subjected to one cycle of energization and de-energization, causing the lock pin 311 to enter the first slide slot 322.

In contrast, the limiting seat 31 is provided with a drive tooth 312, and a guide slope 341 is provided between the drive tooth 331 and the drive tooth 312; When the electromagnetic valve 2 is energized, the movable plunger 21 axially compresses the limiting seat 31 and the drive unit, causing the drive gear 331 to axially press against the transmission gear 312. At this point, the guide slope 341 is used to drive the transmission gear 312 to rotate circumferentially. Through the wedge-shaped engagement between the drive gear 331 and the transmission gear 312, the axial pressure output by the movable plunger 21 is converted into rotational driving force.

In this embodiment, the limiting seat 31 is disk-shaped and mounted on the movable plunger 21. As shown in FIG. 3, the movable plunger 21 has limiting protrusions 213 corresponding to the limiting seat 31 to limit the axial movement of the limiting seat 31. The separately manufactured limiting seat 31 facilitates manufacturing.

In this embodiment, the limiting seat 31 is provided with a first installation slot 310, which extends radially outward from the center hole of the limiting seat 31 corresponding to the movable plunger 21 to the outer edge of the limiting seat 31. The slide seat 32 is provided with a cavity 320 for accommodating the rotation of the limiting seat 31, and the cavity 320 is used to restrict the radial movement of the limiting seat 31. This facilitates the installation of the limiting seat 31 from the side of the movable plunger 21.

In this embodiment, the drive unit is a pressure plate 33, which is disposed on the side of the limiting seat 31 near the plug head 211. The pressure plate 33 is disposed on the movable plunger 21, and the drive teeth 331 are disposed on the pressure plate 33. Opposite the drive teeth 331, the limiting seat 31 is provided with a drive tooth 312, and the limiting seat 31 is slidably mounted on the movable plunger 21. The side of the limiting seat 31 remote from the plug head 211 is provided with a limiting support portion;

As shown in FIGS. 3 to 5, when the electromagnetic valve 2 is energized, the movable plunger 21 axially pushes the pressure plate 33 to axially press the drive teeth 331 against the transmission teeth 312, thereby rotating the transmission teeth 312 in a circumferential direction. At this time, the limiting support portion is used to support the limiting seat 31.

In this embodiment, the limiting support portion is an elastic member 35, which has a cushioning and noise-reducing effect. Specifically, the elastic member 35 is a compression spring, which reduces friction during the rotation of the limiting seat 31. In this embodiment, the drive teeth 312 are disposed on the axial end face of the lock protrusion 311. In this embodiment, the lock protrusion 311 is provided with five pieces, arranged in a circumferential direction, and a plurality of drive teeth 331 are arranged in a circumferential direction.

In this embodiment, a circumferential locking structure is provided between the pressure plate 33 and the sliding seat 32, including a positioning protrusion 332 extending from the outer side of the pressure plate 33 and a second sliding groove 323 extending axially from the inner side of the sliding seat 32, wherein the positioning protrusion 332 is slidably disposed within the second sliding groove 323. Specifically, there are four locating protrusions 332, which are arranged in a circumferential direction at equal intervals.

In other embodiments, the circumferential locking structure may also be provided between the pressure plate 33 and the movable plunger 21. When the pressure plate 33 is fixed to the movable plunger 21, the circumferential locking structure may be provided between the movable plunger 21 and the sliding cavity of the electromagnetic valve 2 corresponding to the movable plunger 21. In this embodiment, the pressure plate 33 is slidably mounted on the movable plunger 21, and the movable plunger 21 has a pressing surface 212 at its upper end corresponding to the pressure plate 33. The pressure plate 33 is axially driven to move by the pressing surface 212.

Specifically, the pressure plate 33 is provided with a second installation slot 330 similar to the first installation slot 310, and the cavity 320 is also used to restrict the radial movement of the pressure plate 33.

In this embodiment, the protruding flange 321 on the side near the locking protrusion 311 is provided with at least a pair of inclined teeth 3211, and positioning slots 3210 are provided between adjacent inclined teeth 3211. When in the second pressure relief state, the locking protrusion 311 contacts the positioning slots 3210; In the unidirectional rotational direction of the limiting seat 31, the tooth surfaces of the inclined teeth 3211 near the first sliding slot 322 are inclined in the circumferential direction,
and the tooth surfaces of the inclined teeth 3211 on the side opposite the first slide slot 322 are perpendicular to the circumferential direction. When the electromagnetic valve 2 is de-energized, the movable plunger 21 is acted upon by the force of the first spring 22 and moves toward the partition plate 101. The inclined teeth 3211 and the positioning slots 3210 are used to prevent the limiting seat 31 from rotating in the opposite direction during this process. Specifically, the lock protrusion 311 is provided with a inclined surface corresponding to the inclined tooth surface of the inclined tooth 3211 (the inclined surface serves as the guide inclined surface 341 on the drive tooth 312). In this embodiment, the inclined tooth surface of the inclined tooth 3211 on the side near the first slide slot 322 extends into the first slide slot 322.

Since the isolation valve requires airtightness testing in the pressure-holding state, and once it enters the second pressure-relief state and then returns to the pressure-holding state, it cannot re-enter the second pressure-relief state, traditional methods such as the one disclosed in application No. 202410579011.3, which features

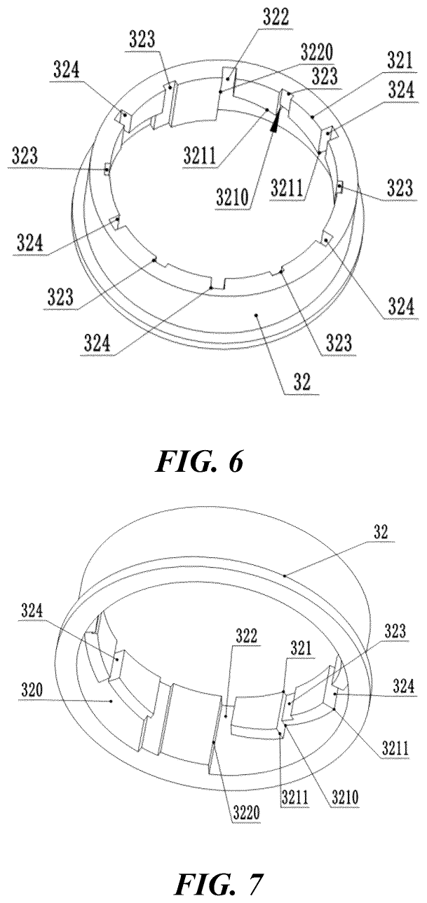

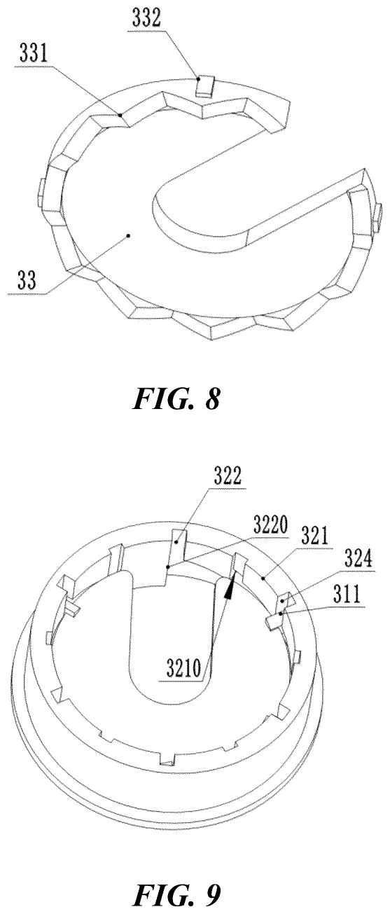

switching power-off pressure relief function, after completing the airtightness test, the solenoid valve is energized to enter the first pressure relief state. Before power is cut off, the moving plunger is limited by manually pushing the lever assembly, causing the fuel tank isolation valve to enter the second pressure relief state. This design has the drawback of being cumbersome to operate. In response to this, as shown in FIG. 6, in this embodiment, the protruding flange 321 is provided with an insertion slot 324, which extends axially outward and penetrates the protruding flange 321. The insertion slot 324 is adapted to the lock protrusion 311; In the unidirectional rotational direction of the limiting seat 31, the installation slot 324 is positioned on the side of the protruding flange 321 opposite the first slide slot 322.

The insertion slot 324 is used to accommodate the lock protrusion 311 entering the slide seat 32 when the limiting seat 31 is axially inserted. In this embodiment, the vertical tooth faces of the helical teeth

3211 face the side wall of the loading slot 324.

The installation slot 324 is provided to facilitate the installation of the limiting seat 31 into the sliding seat 32 when the electromagnetic valve 2 is de-energized. As shown in FIG. 9, in the initial state, the lock protrusion 311 is located within the installation slot 324, at which point the limiting seat 31 and the sliding seat 32 are axially unlocked, and the fuel tank isolation valve is in a pressure-holding state. When electromagnetic valve 2 is energized, the limit seat 31 is pushed so that the locking protrusion 311 moves axially inward and exits the mounting slot 324. Due to the action of the conversion device, after the locking protrusion 311 exits the mounting slot 324, the limit seat 31 rotates circumferentially, causing the locking protrusion 311 to misalign with the mounting slot 324. When the solenoid valve 2 is de-energized again, as shown in FIG. 10, the lock pin 311 cannot enter the mounting slot 324. At this point, the isolation valve is in the second pressure relief state. Therefore, in this embodiment, the fuel tank isolation valve can automatically enter the second pressure relief state after completing the airtightness test in the pressure-holding state by simply controlling the energization and de-energization of the solenoid valve 2, thereby achieving the advantages of simple operation and high automation.

### Example 3

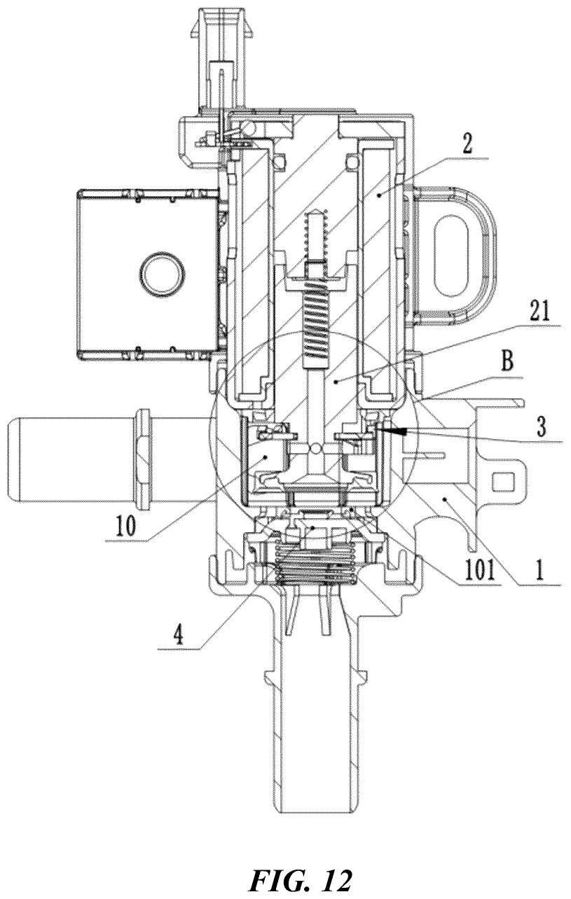

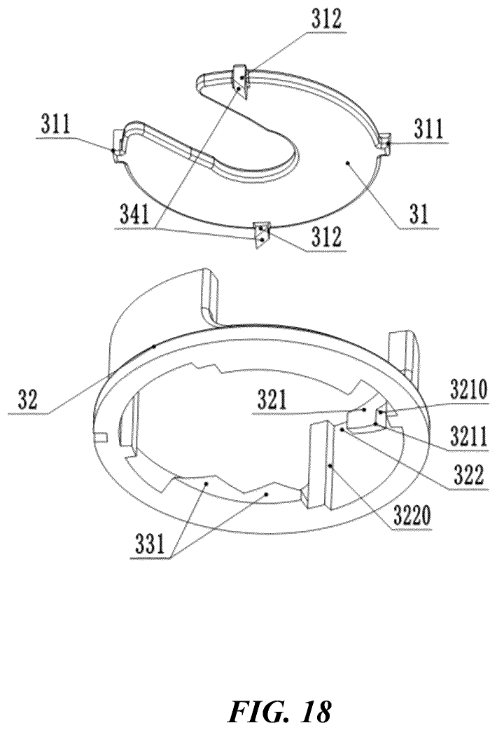

Referring to FIGS. 12 to 18, the embodiment further comprises, based on the embodiment 1:

A temporary power failure pressure relief device 3, wherein the temporary power failure pressure relief device 3 includes a limit seat 31, a sliding seat 32, and a conversion device; the sliding seat 32 is disposed at the front end of the electromagnetic valve 2 valve body, and the limit seat 31 is disposed on the movable plunger 21;

Second pressure relief state: When the electromagnetic valve 2 is de-energized, the first spring 22 pushes the movable plunger 21 to axially abut against the limiting seat 31 and the sliding seat 32, thereby restricting the plug 211 from blocking the through hole 1011. Correspondingly, the limiting seat 31 and the sliding seat 32 are respectively provided with axially opposing locking protrusions 311 and flanges 321;

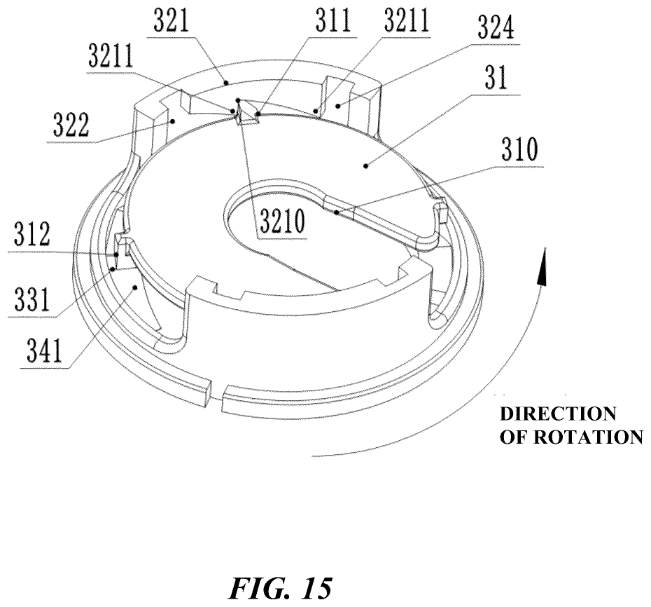

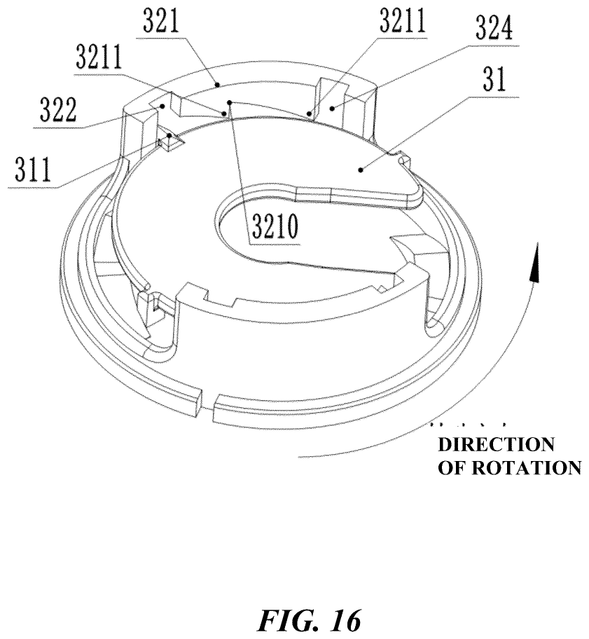

The conversion device is used to convert the axial driving force of the movable plunger 21 on the limit seat 31 into a driving force to cause the limit seat 31 to rotate unidirectionally in the circumferential direction (the process of unidirectional rotation is shown in FIGS. 15 to 16); The protruding flange 321 has a first slide groove 322 on one side for accommodating the axial sliding of the locking protrusion 311;

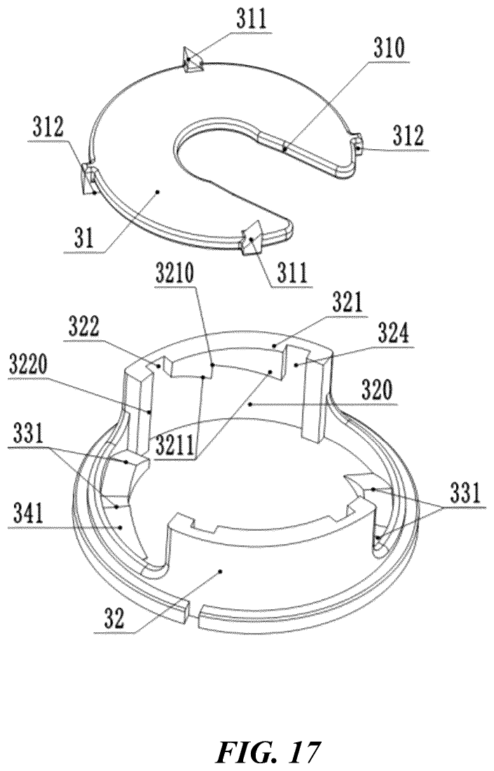

The device further includes a rotational blocking structure. After the locking protrusion 311 rotates into the first slide groove 322, the blocking structure is used to restrict the limiting seat 31 from continuing to rotate circumferentially. Referring to FIGS. 16 and 17, in this embodiment, corresponding to the rotational blocking structure, the first slide groove 322 is provided with a side wall 3220 for restricting the limiting seat 31 from continuing to rotate circumferentially. Specifically, the side wall 3220 extends outward in the direction away from the plug 211 to form a protruding flange 321.

The first slide groove 322 is provided with side walls 3220 for restricting the further circumferential rotation of the limiting seat 31. Specifically, the side walls 3220 extend outward in the direction away from the plug 211 to form projecting flanges 321.

Specifically, in this embodiment, after the fuel tank isolation valve is in the second pressure relief state, the electromagnetic valve 2 is energized and de-energized for one cycle, causing the locking protrusion 311 to enter the first slide groove 322.

In this embodiment, the conversion device includes a circumferentially locked drive unit, which is disposed on the axial side of the limiting seat 31. The drive unit has drive teeth 331 on the side near the limiting seat 31, and opposite to the drive teeth 331, the stop seat 31 is provided with a drive gear 312, and a guide slope 341 is provided between the drive teeth 331 and the drive gear 312; When the electromagnetic valve 2 is energized, the movable plunger 21 axially compresses the limiting seat 31 and the drive unit, causing the drive teeth 331 to axially press against the transmission teeth 312. At this point, the guide inclined surface 341 is used to drive the transmission teeth 312 to rotate circumferentially. Through the wedge-shaped engagement between the drive teeth 331 and the transmission teeth 312, the axial pressure output by the movable plunger 21 is converted into rotational driving force.

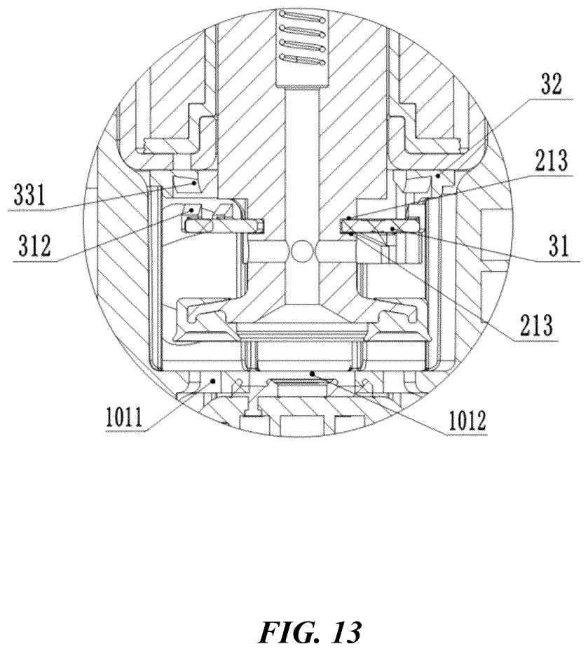

Unlike Example 2, in this example, the drive teeth 312 and the lock protrusions 311 are circumferentially spaced apart. Based on this structure, in other examples, a stop wall with the same principle as the side wall 3220 can be provided for the drive teeth 312 as a rotational blocking structure. In this embodiment, the limiting seat 31 is disk-shaped and mounted on the movable plunger 21. As shown in FIG. 13, the movable plunger 21 has a limiting protrusion 213 corresponding to the limiting seat 31 to limit the axial movement of the limiting seat 31. The separately manufactured limiting seat 31 facilitates manufacturing. In other embodiments, the limiting seat 31 may be fixed to the movable plunger 21, in which case the movable plunger 21 is rotatably mounted within the electromagnetic valve 2.

In this embodiment, the limiting seat 31 is provided with a first installation slot 310, which extends radially outward from the center hole of the limiting seat 31 corresponding to the movable plunger 21 to the outer edge of the limiting seat 31. The slide seat 32 is provided with a cavity 320 for accommodating the rotation of the limiting seat 31, and the cavity 320 is used to restrict the radial movement of the limiting seat 31.

As shown in FIGS. 13 to 18, in this embodiment, the drive unit is fixedly mounted on the side of the limiting seat 31 remote from the plug 211; when the solenoid valve 2 is energized, the movable plunger 21 axially pushes the limiting seat 31 to axially press the drive tooth 331 against the transmission tooth 312, thereby causing the transmission tooth 312 to rotate in a circumferential direction. Based on the above structure, the drive unit can be integrated into the front end of the valve body of the electromagnetic valve 2 or the bottom end of the slide block 32, thereby eliminating the need to manufacture the pressure plate 33 compared to Example 2, thereby reducing production costs. In this embodiment, the drive unit is integrally formed at the bottom of the slide block 32. In this embodiment, the lock protrusion 311 is provided in a pair, and the drive teeth 312 are provided in a pair.

In this embodiment, the protruding flange 321 on the side near the lock protrusion 311 is provided with at least a pair of inclined teeth 3211, and positioning slots 3210 are provided between adjacent inclined teeth 3211. When in the second pressure relief state, the lock protrusion 311 contacts the positioning slots 3210; In the unidirectional rotational direction of the limiting seat 31, the tooth surfaces of the inclined teeth 3211 near the first slide slot 322 are inclined in the circumferential direction, and the tooth surfaces of the inclined teeth 3211 on the side opposite the first slide slot 322 are perpendicular to the circumferential direction. When the electromagnetic valve 2 is de-energized, the movable plunger 21 is acted upon by the force of the first spring 22 and moves toward the partition plate 101. The inclined teeth 3211 and the locating slots 3210 are used to prevent the limiting seat 31 from rotating in the opposite direction during this process. Specifically, the locking protrusion 311 is provided with a inclined surface corresponding to the inclined tooth surface of the inclined tooth 3211. In this embodiment, the inclined tooth surface of the inclined tooth 3211 on the side near the first slide slot 322 extends into the first slide slot 322.

In this embodiment, the protruding flange 321 is provided with an insertion slot 324, which extends axially outward and penetrates the protruding flange 321, and the insertion slot 324 is adapted to the lock protrusion 311; In the unidirectional rotational direction of the limiting seat 31, the insertion slot 324 is positioned on the side of the protruding flange 321 opposite the first slide slot 322. The insertion slot 324 is used to accommodate the lock protrusion 311 entering the slide seat 32 when the limiting seat 31 is axially inserted. In this embodiment, the vertical tooth faces of the helical teeth 3211 correspond to the side walls of the insertion slot 324.

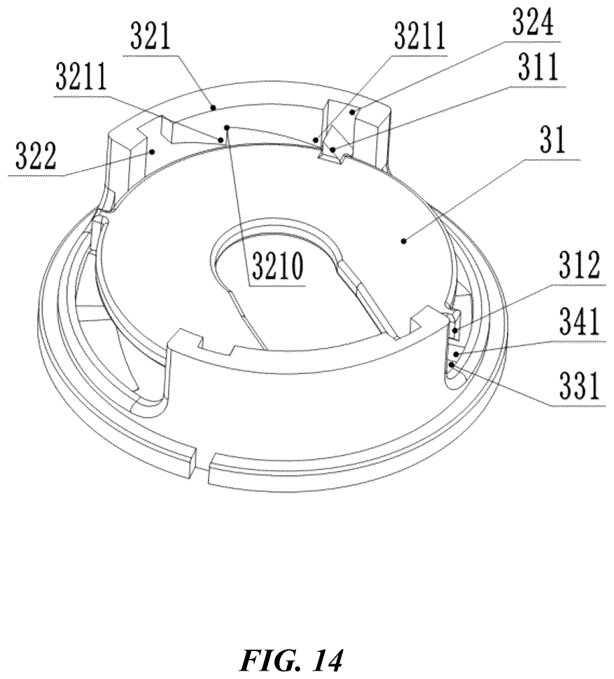

The installation slot 324 is provided to facilitate the installation of the limiting seat 31 into the sliding seat 32 when the electromagnetic valve 2 is de-energized. As shown in FIG. 14, in the initial state, the lock protrusion 311 is located within the installation slot 324, at which time the limiting seat 31 and the sliding seat 32 are axially unlocked, and the fuel tank isolation valve is in the pressure-holding state. When electromagnetic valve 2 is energized, the limit seat 31 is pushed so that the locking protrusion 311 moves axially inward and exits the installation slot 324. Due to the action of the conversion device, after the locking protrusion 311 exits the installation slot 324, the limit seat 31 rotates circumferentially, causing the locking protrusion 311 to misalign with the installation slot 324. When electromagnetic valve 2 is de-energized again, as shown in FIG. 15, lock pin 311 cannot enter slot 324, and the isolation valve is in the second pressure relief state. Therefore, in this embodiment, the fuel tank isolation valve can automatically enter the second pressure relief state after completing the airtightness test in the pressure-holding state by simply controlling the energization and de-energization of electromagnetic valve 2, thereby achieving the advantages of simple operation and high automation.

The above description of the technical principles of the present invention is based on specific embodiments. These descriptions are provided solely to explain the principles of the present invention and should not be construed in any way as limiting the scope of protection of the present invention. Based on the above explanation, those skilled in the art can readily conceive other specific embodiments of the present invention without creative labor, and such embodiments will fall within the scope of protection of the present invention.

In the drawings:
1—isolation valve main body;
10—valve cavity;
101—partition plate;
1011—through hole;
1012—pressure release hole;
2—electromagnetic valve;
21—movable plunger;
210—pressure relief flow passage;
211—plug;
212—pressing surface;
213—limiting lug boss;
22—the first spring;
3—temporary power-off pressure relief device;
31—limiting seat;
310—the first mounting groove;
311—locking convex;
312—transmission teeth;
32—sliding seat;
323—second chute;
324—loading groove;
33—platen;
330—second mounting groove;
331—driving teeth;
332—locating convex;
341—guiding inclined plane;
35—clastic piece;
4—pressure relief valve plug;
41—the second spring.

1. A fuel tank isolation valve, comprising:
an isolation valve body, wherein a valve cavity is provided in the isolation valve body, a partition plate is provided in the valve cavity, and a through hole is provided on the partition plate for connecting flow channels on both sides of the partition plate;
a solenoid valve, the solenoid valve being mounted on the isolation valve body, the solenoid valve comprising a movable plunger extending into the valve chamber, a plug being provided at the front end of the movable plunger, the plug being directly opposite to the partition, and a first spring being in contact with a side of the movable plunger away from the partition; wherein the solenoid valve moves between a pressure-holding state when the solenoid valve is powered off,
and the first spring pushes the movable plunger to the plug to block the through hole; and
a first pressure relief state when the solenoid valve is energized, in which the movable plunger retracts away from the partition to the through hole and opens; and
a temporary power-off pressure relief device, the temporary power-off pressure relief device comprising a limit seat, a slide seat and a conversion device, the slide seat being arranged at the front end of a valve body of the solenoid valve, and the limit seat being arranged on the movable plunger; wherein the conversion device is used to convert the axial driving force of the movable plunger on the limit seat into driving the limit seat to rotate unidirectionally in the circumferential direction; and wherein the temporary power-off pressure relief device enables a second pressure relief state of the solenoid valve when the solenoid valve is powered off, in which the first spring pushes the movable plunger to axially contact the limit seat and the slide seat to limit the plug from blocking the through hole.

2. The fuel tank isolation valve of claim 1, wherein the limit seat and the slide seat are respectively provided with axially opposite locking protrusions and protruding flanges.

3. The fuel tank isolation valve of claim 2, wherein a first sliding groove shaped to accommodate the locking protrusion for axial sliding is provided on one side of the protruding flanges.

4. The fuel tank isolation valve of claim 3, wherein the temporary power-off pressure relief device includes a rotation blocking structure, which is configured to limit the limit seat from continuing to rotate in the circumferential direction after the receiving lock protrusion rotates into the first sliding groove.

5. The fuel tank isolation valve of claim 1, wherein the conversion device comprises a circumferentially locked driving part, the driving part is arranged on one axial side of the limit seat, a driving tooth is provided on the side of the driving part near the limit seat, and a transmission tooth is provided on the limit seat opposite to the driving tooth, and
wherein a guiding inclined surface is provided between the driving tooth and the transmission tooth; and
wherein the temporary power-off pressure relief device is configured such that when the solenoid valve is energized, the movable plunger axially presses the limit seat and the drive portion until the drive tooth axially presses the transmission tooth such that the guide inclined surface is used to push the transmission tooth to rotate circumferentially.

6. The fuel tank isolation valve according to claim 5, wherein the driving part is a pressure plate, the pressure plate is arranged on the side of the limit seat close to the plug, the pressure plate is arranged on the movable plunger, the driving tooth is arranged on the pressure plate, and the limit seat is provided with a transmission tooth opposite to the driving tooth, the limit seat is slidably sleeved on the movable plunger, and the limit seat is provided with a limit support part on the side away from the plug;
and wherein when the solenoid valve is energized, the movable plunger axially pushes the pressure plate until the drive tooth axially presses the transmission tooth to push the transmission tooth to rotate circumferentially such that the limit support portion is used to support the limit seat.

7. The fuel tank isolation valve according to claim 6, wherein a circumferential locking structure is provided between the pressure plate and the slide seat, comprising a positioning protrusion extending outside the pressure plate and a second slide groove axially extending inside the slide seat, wherein the positioning protrusion is slidably provided in the second slide groove.

8. The fuel tank isolation valve according to claim 7, wherein the pressure plate is slidably sleeved on the movable plunger, and the movable plunger is provided with a pressing surface corresponding to the upper end of the pressure plate.

9. The fuel tank isolation valve according to claim 5, wherein the driving part is fixedly arranged on the side of the limit seat away from the plug; wherein the temporary power-off pressure relief device is configured such that after the solenoid valve is energized, the movable plunger axially pushes the limit seat until the transmission tooth axially presses the driving tooth to push the transmission tooth to rotate circumferentially.

10. The fuel tank isolation valve according to claim 1, wherein the limit seat is in the form of a disk, sleeved on the movable plunger, and the corresponding limit seat on the corresponding movable plunger is provided with a limit boss for driving the limit seat to move axially.

11. The fuel tank isolation valve according to claim 10, wherein a first mounting groove is provided on the limit seat, the first mounting groove radially extends from the center hole of the limit seat corresponding to the movable plunger to the outer edge of the limit seat, and a cavity for accommodating the rotation of the limit seat is provided in the slide seat, and the cavity is used to limit the radial movement of the limit seat.

12. The fuel tank isolation valve according to claim 2, wherein a convex flange is provided with at least one pair of oblique teeth on one side near the locking protrusion, and a positioning groove is provided between adjacent oblique teeth, and wherein the temporary power-off pressure relief device is configured such that when the solenoid valve is in the second pressure relief state, the locking protrusion abuts against the positioning groove.

13. The fuel tank isolation valve according to claim 12, wherein the convex flange is provided with a loading groove, the loading groove extends axially outward through the convex flange, and the loading groove is adapted to the locking protrusion.

14. The fuel tank isolation valve according to claim 4, wherein the rotation blocking structure is a side wall on the first sliding groove.

15. A fuel tank isolation valve, comprising:
an isolation valve body, wherein a valve cavity is provided in the isolation valve body, a partition plate is provided in the valve cavity, and a through hole is provided on the partition plate that fluidly couples an inlet to an outlet on opposite sides of the partition plate;
a solenoid valve including a movable plunger extending into the valve chamber, and a first spring arranged to bias the movable plunger toward the partition plate, wherein the solenoid valve moves between
a pressure-holding state when the solenoid valve is powered off, and the first spring pushes the movable plunger to block the through hole,
a first pressure relief state when the solenoid valve is energized, in which the movable plunger retracts away from the partition to the through hole and opens, and
a second pressure relief state when the solenoid valve is powered off, in which the first spring pushes the movable plunger toward the through hole but the movable plunger is restrained from blocking the through hole; and
a temporary power-off pressure relief device configured to restrain the movable plunger of the solenoid valve from blocking the through hole when the solenoid valve is in the second pressure relief state, the temporary power-off pressure relief device including a limit seat, a slide seat, and a conversion device, wherein the limit seat and the slide seat cooperate in an engaged position to resist motion of the movable plunger toward the partition plate, and wherein the conversion device is configured to convert axial motion of the movable plunger into rotational motion of the limit seat or the slide seat so as to move the limit seat and the slide seat to a disengaged position in which they do not resist motion of the movable plunger toward the partition plate.

16. The fuel tank isolation valve of claim 15, wherein the limit seat is arranged on the movable plunger and the conversion device is configured to convert axial motion of the movable plunger away from the partition plate in response to the solenoid valve being energized into rotational motion of the limit seat.

17. The fuel tank isolation valve of claim 16, wherein the temporary power-off pressure relief device includes a rotation blocking structure, which is configured to limit the limit seat from continuing to rotate in the circumferential direction after movement of the limit seat and the slide seat to the disengaged position in which they do not resist motion of the movable plunger toward the partition plate.
